(19) United States
(12) Patent Application Publication
(10) Pub. No.: US 2006/0014488 A1
(43) Pub. Date: Jan. 19, 2006

(54) Communication system

(76) Inventors: Mark Davis, Gulfport, MS (US); Kim Cameron, Biloxi, MS (US)

Correspondence Address: KEATY PROFESSIONAL LAW CORPORATION;THOMAS S. KEATY, 2533 AMERICAN WAY, PORT ALLEN, LA, 70767, US

(21) Appl. No.: 10/891,322

(22) Filed: Jul. 14, 2004

(51) Int. Cl. H04H 1/00

(52) U.S. Cl. 455/3.01

(57) ABSTRACT

A wireless network system for distributing broadband signals through a plurality of terminal devices located a distance from the origination point of the broadband signals, such as a cell tower. The wireless network has an interface point (receiving antenna) for communicating signaling data from the service point to a selected one of the terminal devices, such as a subscriber's computer. The wireless network allows transmission of a radio-frequency signal to a number of service subscribers, who have special antennas mounted on their buildings. The network system establishes radio to network communications between the cell tower and an individual point of service location The antennas convert the received signal to allow establishing broadband Internet connection.

### BACKGROUND OF THE INVENTION

This invention relates to communication systems, and more particularly, to a wireless broadband network and equipment for use in such networks for establishing wireless communication.

In recent years, a number of new services have been offered to consumers to allow establishing network communications between a customer's computer and other Internet service providers. These include access points in airports, Internet cafes, and other such places also known as Y-Fi hot spots. Y-Fi cells having 2.4 gig capacity transmit Internet traffic between the service provider and a selected hot spot location, for instance a room in a building or in some cases, the entire building. The recent trend is to use the Y-Fi cells through a wireless network, without having to run fibreoptic cables or coaxial cables into individual homes. The Y-Fi signals are transmitted from a central tower or beacon to the individual hot spots. The problem with this type of communication is that at present, there is no cost effective reliable and easy way to establish a network based on Y-Fi cells directly from the tower to individual hot spots.

Conventionally, wireless services have large antennas placed at strategic locations where interference from buildings, landscape, or vegetation is minimized. The broadcasting antenna usually provides a 120-degree overlap in the circular transmission zones. Some of the antennas have the capability of transmitting to 5-15 mile coverage areas; others have as short as a 1-mile signal transmission.

Recent developments in the communication technology have led to the spread of different wideband distribution networks for offering subscribers an array of video services, including video on demand service, which allows the user to selectively choose a particular video to be transmitted to the user's antenna. Some technical solutions include provision of a wireless cable system using a bi-directional converter with a single microwave antenna to receive microwave-programming signals at a first set of frequencies then transmit data as upstream signals at a second set of frequencies. However, if the signal from the central tower is not strong enough, the receiver of the individual user will fail to receive and transmit the required communication services, as is often the case with the wireless Internet service providers (ISPs).

The present invention contemplates elimination of drawbacks associated with the prior art and provision of a broadband communication network which will enable the user to pick up the signal through an antenna mounted on the individual's house, similar to television antennas, and access the Internet through the antenna.

### SUMMARY OF THE INVENTION

It is, therefore, an object of the present invention to provide a wireless network access capability to individual users to conveniently communicate with the wireless network system.

Another object of the present invention is to provide a wireless network access antenna for receiving various or different frequencies.

A further object of the present invention is to provide a radio antenna mountable on a vertical surface for establishing the wireless network access to an individual building.

These and other objects of the present invention are achieved through a provision of a wireless network system for distributing broadband signals through a plurality of terminal devices located a distance from the origination point of the broadband signals. The wireless network comprises an interface point for communicating signaling data from the service point to an interface point and then to a selected one of the terminal devices, such as a computer located inside a subscriber's premises. The wireless network allows transmission of a radio-frequency signal to a number of service subscribers, who have special antennas mounted on their buildings. The network system establishes radio to network communications between the cell tower and an individual point of service location The antennas convert the received signal to allow establishing broadband Internet connection through a computer connected to the receiving antenna.

The antenna assembly comprises an electronic circuit, which has a 2.4-gig bridge connected to the antenna receiver. A radio card, PCMCIA card is electronically connected to a cable leading from the antenna body and slides inside the circuit motherboard. The PCMCIA card converts the radio frequency to a network protocol. The circuit also contains a number of knobs, such as a power knob, a reset knob, and a connector knob for connecting the motherboard to CAT-5 cable.

The cable extends into the interior of the building, on which the antenna assembly is mounted. Inside the building, the network system uses a standard power source, which can be a 12-volt DC power source to inject power, which is connected to a communications device, and into the communication port thereof. The same power source injects power into the CAT-5 cable and to the radio mounted on the outside of the building. A network cable extends from the adapter device to a crossover cable, where the user may have a selection of routing the signal to a computer or to pass through a cable to another device, for instance a switch router or communication hub.

### BRIEF DESCRIPTION OF THE DRAWINGS

Reference will now be made to the drawings, wherein like parts are designated by like numerals, and wherein

FIG. 1 is a general schematic view of the network system of the present invention communicating with a cell tower.

FIG. 2 is a schematic view of the wireless network in accordance with the present invention for establishing radio to network communications between the cell tower and an individual point of service location.

FIG. 3 is a detail view of the antenna in accordance with the present invention mounted on a side of a building.

FIG. 4 is a partial exploded view illustrating the antenna of the present invention.

FIG. 5 is a detail view of a wall plate mountable on the side of a building.

FIG. 6 is a detail back view of the antenna housing.

FIG. 7 is a detail front view of the antenna housing.

FIG. 8 is a schematic view illustrating transmission of the signal inside the user's building.

FIG. 9 is a schematic view of the electronic circuit components for converting radio frequency signals to network protocol for use in the system of the present invention.

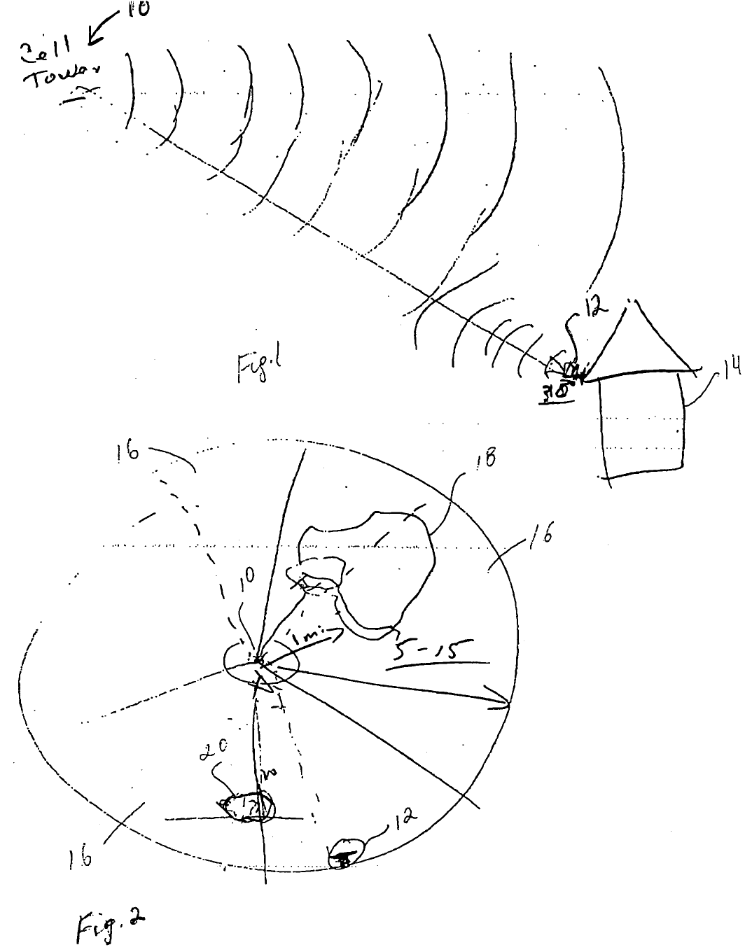

### DETAILED DESCRIPTION OF THE PREFERRED EMBODIMENT

Conventional wireless network systems use one or more access devices for establishing communication between the service provider and the end user. The users may be communicated with the access device with personal computers or notebook computers that have wireless network cards wired in the computer. Some of the communicating devices are Institute of Electrical and Electronic Engineers (IEEE) 801.11.a, IEEE 802.11.b and IEEE 802.11.g. The IEEE frequency device is selectively operable with an IEEE 802.11.a, IEEE 802.11.b, or an IEEE 802.11.g or the combination of the frequencies in order to allow the signals of different frequencies to be quickly transmitted or communicated with each other. In addition to communicating at predetermined frequencies, the access devices also have to check the service set identifier or SSID of the user.

Similarly to the conventional communication systems, the system of the present invention receives signals from a conventional communications transmitter, such as a cell tower 10. The signal may be transmitted as 2.4 or 5.8 gig signal. The cell tower 10 transmits the radio signal that is picked up a distance away by a number of terminal devices through an interface point, such as antenna 12. In the system of the present invention, the radio antenna 12 is secured to a building 14 and is oriented towards the signal path of radio waves emitted by the tower 10. The subscriber's radio has a 30-degree path, and the signals are received by the antenna 12, when the antenna is properly oriented towards the transmitter 10.

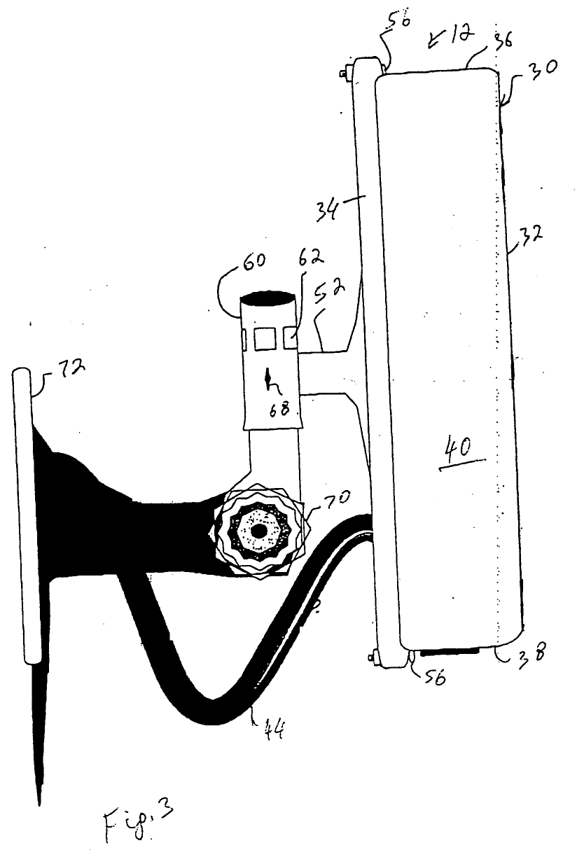

As schematically shown in FIG. 2, conventionally, a signal transmitted by the tower 10 is spread with overlapping 120-degree segments 16. An obstruction, 18, which can be tall trees, elevations or tall buildings, interferes with the normal wave distribution of the signal within a certain zone. At such zones, the signal may be transmitted to a distance of about one mile. To solve the problem of inadequate signal reception, the network system of the present invention allows conversion of a radio signal to a network communication signal by an antenna circuit, thereby increasing the distance of reception to 5-15 mile radius from the point of origin of the cell tower 10.

Another type of interference may be prevented by a radio 20, which may be a Linksis radio. The communication system of the present invention operates at IEEE 802.1.b/g and it is expected to have 11 channels in the range between 2.4-5.8 gig. When there is no interference by landscape for transmitter, the antenna 12 will receive the signal as a radio signal emitted by the tower 10. The signal received by antenna 12 is converted from the radio frequency to TCP-IP (Internet Protocol). It is envisioned that within the 11-channel distribution received by antenna 12, the user will be able to select the broadcasting channel, which responds to the strongest signal in the particular location. To prevent overlapping of the signals, the communication network of the present invention may omit 2 or 3 channels between each broadcasting channel. The administrative protocol allows receipt of the signal only by the designated antennas within the network of the system.

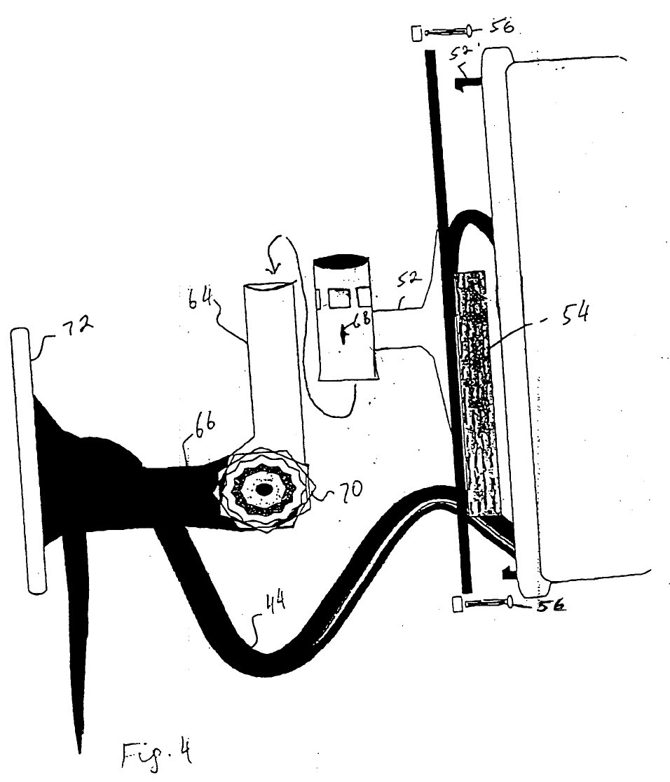

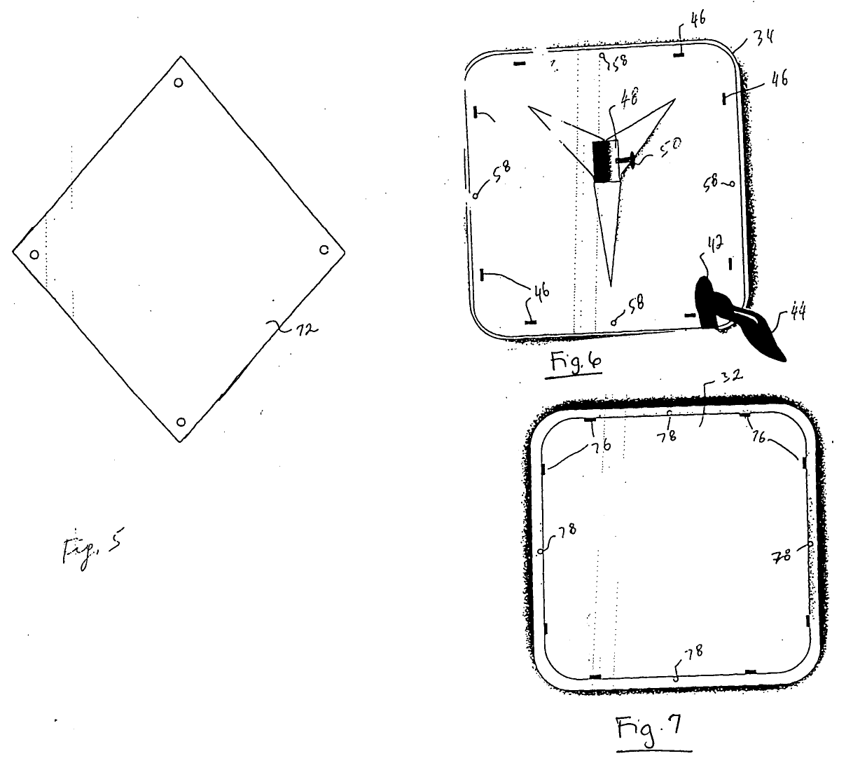

Turning now to FIGS. 3-7, the antenna assembly for use in the communication system of the present invention is shown in more detail. The antenna assembly 12 comprises a housing 30 having a front panel 32, a back panel 34, a top panel 36, a bottom panel 38, and side panels 40. An opening 42 is formed adjacent the bottom of the back panel 34 to allow extension of a CAT-5 cable 44 therethrough.

A plurality of slots 46 is formed above the peripheral edge of the back panel 34 to allow engagement of the back panel 34 with the side panels 40, top panel 36, and the bottom panel 38. A central opening 48 formed in the back panel 34 shows a securing screw 50 for attachment of the back panel to a support arm 52. A plurality of hook-shaped retainers 52 engage within the slots 46 to allow forming of a unitary body, the housing 30.

A radio 54 is mounted inside the housing 30 for receiving the radio signal transmitted by the tower 10. A pair of screws 56 extend through corresponding openings 58 formed in the back panel 34 ensuring the engagement of the side panels 40 with the back panel 34. The support arm 52 engages the back panel 34 in the center part thereof. A distant end of the support arm 52 carries a sleeve 50, which has a tubular configuration and is provided with a plurality of slots 62 placed equidistantly about the periphery thereof. The slots 62 extend through the wall of the sleeve 60 and are adapted for receiving a tightening clamp (when necessary) for retaining the sleeve 60 on a shaft 64 of the mounting bracket 66.

A longitudinal slot 68 is formed in the sleeve 60 for receiving a thumbscrew therein. The thumbscrew normally retains the sleeve 60 and the antenna housing 30 in a desired orientation and position on the mounting bracket 66. If the integrity of the thumbscrew is compromised, a clamping band inserted through the slots 62 tightens the sleeve 60 on the shaft 64. The mounting bracket 66 is an elbow bracket that can tilt about two axes: vertical (up and down) and horizontal (side to side). An adjustment knob 70 can be turned by an installer to orient the shaft 64, which supports the antenna housing 30, at the best angle to receive the signal from the tower 10.

A mounting plate 72 is adapted for attachment to a side of the housing, for instance a residence of the user in the location most beneficial for receiving the signal from the tower 10. The mounting plate 72 may be attached by nails, screws or other conventional methods in the eaves area or other convenient location. The network cable 44 extends from the housing 30, through the plate 72 into the interior of the user's building. The network cable 44 provides power to the radio 54 and provides data back into the network. It is envisioned that the power injector inside the user's building may be used to provide power to the radio 54.

The front panel 32, similarly to the back panel 34, is provided with a plurality of peripheral slots 76 which are adapted for receiving hook-shaped retainers (not shown) therethrough. The front panel 32 is further provided with openings 78 which are designed for receiving retaining screws therein.

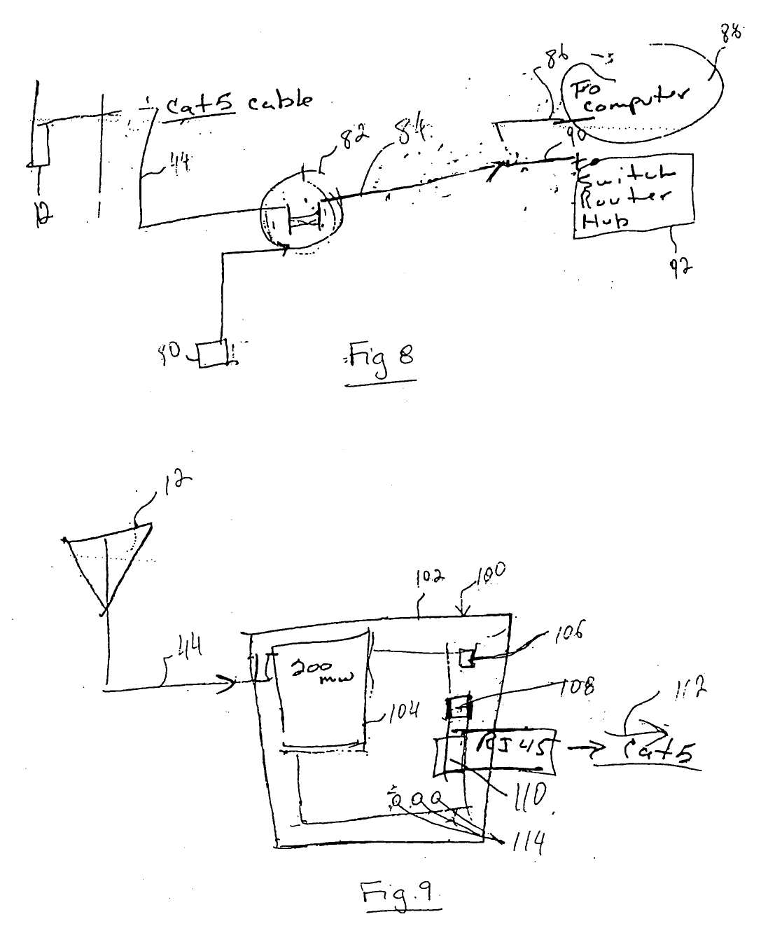

Inside the building 14, the network system uses a standard power source 80, which can be a 12-volt DC power source to inject power to the system. The power source is coupled through a communication port to adapter 82. The same power source 80 injects power into the CAT-5 cable 44 and to the radio 12 mounted on the outside of the building. A network cable 84 extends from the adapter device 82 to a crossover bridge 86, which allows the user to route the signal to a computer 88 or to a pass-through cable 90. The user may connect the cable 90 to a variety of receivers, for instance a switch router or communication hub, schematically designated as device 92 in FIG. 8.

FIG. 9 schematically illustrates the functional elements of the network communication device located inside the housing 30. The circuit motherboard 100 has 2.4-gig bridge 102 connected to the antenna 12. A radio card, or PCMCIA card 104 is electronically connected to the cable 44 and slides inside the motherboard 100. The PCMCIA card 104 will convert the radio frequency to a network protocol. The circuit also contains a number of knobs, such as a power knob 106, a reset knob 108, and a connector knob 110 for connecting the motherboard 100 to CAT-5 cable 112.

A plurality of indicators 114 are connected to the card 104. The indicators 114 may be LED indicators signaling the present selections of power, network connections, or wireless connection. Should the user lose his communication or password or does not know what the IP address of the radio is, the housing 30 may be opened and the reset button 108 may be pressed to reset the circuit to the factory default. This provides a substantial advantage as compared to conventional systems where the user has to physically disassemble the device to determine the condition of the circuit.

In order to communicate through the communication network of the present invention, the user will need to subscribe to the service and select a password, which will be user specific to the particular computer or to the wireless radio installed in the application.

The communication network of the present invention converts radio frequency signals to networking signals and allows the user to receive signals from similar antenna at a greater distance that has been possible heretofore. The distance of a wireless communication network from the antenna and the Internet service provider can establish service to a greater number of people without concern for interference or breaking of the service by natural obstacles.

Many changes and modifications can be made in the system of the present of the present invention without departing from the spirit thereof. We therefore pray that our rights to the present invention be limited only by the scope of the appended claims.

We claim:

1. A wireless network system for distributing broadband signals through a plurality of terminal devices located a distance from the origination point of the broadband signals, the system comprising an interface point for communicating signaling data from the origination point to a selected one of a plurality of receiver systems.

2. The system of claim 1, wherein the interface point comprises a receiving antenna.

3. The system of claim 1, wherein each receiver system comprises an antenna for receiving a wireless transmission of the signal, an interface module for processing the received signal and converting the received signal from RF mode to network protocol, and a means for forwarding the converted signal to a terminal device for processing data from a selected stream of broadband information contained in the signal.

4. The system of claim 3, wherein further comprising an adapter device for routing the converted signal to a pre-determined terminal device.

5. The system of claim 2, wherein the receiving antenna comprises a directional antenna assembly.

6. The system of claim 5, wherein said directional antenna assembly comprises a housing, a RF receiver mounted inside the housing for receiving the transmitted signal, a support arm for supporting the housing in a selected orientation in relation to the signal origination point and a means for securing the supporting arm and the housing on an exterior of a network subscriber premises.

7. The system of claim 5, wherein said securing means a sleeve carried by a distant end of said support arm and a mounting bracket detachably engaging said support arm.

8. The system of claim 6, wherein said securing means further comprises a mounting plate securable on the exterior of the network subscriber's premises, said mounting bracket being secured to said mounting plate.

9. A method comprising:
detecting a RF signal transmitted by a RF transmitter to a plurality of subscribers through an interface point of a communication network;
in response to detection of the incoming signal, converting the RF signal to a protocol recognizable by a receiver system; and
presenting the converted signal to a terminal device for processing data from a selected stream of broadband information contained in the signal.

10. The method of claim 9, further comprising the step of routing the converted signal to a pre-determined terminal device.
